(19) United States
(12) Patent Application Publication
(10) Pub. No.: US 2018/0362779 A1
(43) Pub. Date: Dec. 20, 2018

(54) Waterproof device and its electroconductive methods

(71) Applicant: DAZZEON Technology Co., Ltd., Taipei City (TW)

(72) Inventors: Chia-Chin Chuang, Taipei City (TW); Chi-Yu Huang, Taipei City (TW)

(21) Appl. No.: 15/996,613

(22) Filed: Jun. 4, 2018

Related U.S. Application Data
(60) Provisional application No. 62/514,100, filed on Jun. 2, 2017.

(51) Int. Cl. C09D 5/24; C09D 183/04; C09D 163/00; C09D 175/04

(52) U.S. Cl. CPC C09D 5/24; C09D 183/04; H02S 40/34; C09D 175/04; C09D 163/00

(57) ABSTRACT

The invention relates to a waterproof device and its electroconductive methods. The waterproof device comprises a body and a coating layer that cover a part or all of surface of the body. The coating layer comprises a recoverable deformation and non-electroconductive material or a material capable of generating quantum-tunnelling electrons. The thickness of the coating layer is more than 30 nm. Furthermore, the electroconductive methods include a contacting electroconductive method.

### TECHNICAL FIELD OF THE INVENTION

The present invention relates to a waterproof device and its electroconductive methods. In particular, the electroconductive methods include contacting electroconductive methods.

### BACKGROUND OF THE INVENTION

In general, traditional waterproof devices have many disadvantages, such as large amounts of leakage current and electrical shortcut. These disadvantages limit the application of the traditional waterproof devices. Secondly, traditional protected film is not able to make waterproof devices electroconductive by contacting electroconductive methods because the protected film does not transfer electrons.

Based on the aforementioned description, an excellently protected waterproof device with ultra-low leakage current is required.

### SUMMARY OF THE INVENTION

In one aspect, the present invention provides a waterproof device. The waterproof device comprises a film and a body, and the film coats a part or all surface of the body. The film is formed by one comprises a recoverable deformation material or a material capable of generating quantum tunnelling electrons. A thickness of the film is more than 30 nm.

In one embodiment, the recoverable deformation material is selected from the group consisting of a paste, an oil, a ester, a polymer, an organic material, an inorganic material, a nanomaterial and their combinations thereof.

Typically, the polymer comprises silicone, epoxy resin or polyurethane.

In one embodiment, the material capable of generating quantum-tunnelling electrons is selected from the group consisting of an insulator, a semi-conductor, a polymer, a paste, electroconductive particles, an organic material, an inorganic material, a nanomaterial and their combinations thereof.

Typically, the polymer comprises silicone, epoxy resin or polyurethane.

In another embodiment, the claimed waterproof device comprises circuit boards, batteries, light-emitting diodes, semi-conductors, panels, connectors, touching panels, keyboards, sensors, chips, electron devices or switches.

In general, the claimed waterproof device has a leakage current less than 10 μA.

In conclusion, the claimed waterproof device comprises a film and a body. The film is coat on surface of the body to protect the body from moisture, corrosion, oxidation, fouling and damages from environment. The film made of one comprises polymers, organic chemicals, inorganic chemicals, nanomaterials, a hybrid of organic and inorganic material, and a hybrid of the above materials and microstructures. In particular, the film is a deformable material and/or capable of generating quantum-tunnelling electrons. Preferable, the film is a self-healing material for recovering the deformation of the film, while the body is a non-insulator.

In another aspect, the present invention provides a method for making the claimed waterproof device electro-conduction. The method comprises steps described as following: provide a conductor perform a procedure to have the conductor contact the film of the claimed waterproof device. The film is formed by a material capable of generating quantum-tunnelling electrons; make the claimed waterproof device electro-conduction by the quantum-tunnelling electrons transferring; and remove the conductor from the film to recover the original shape of the claimed waterproof device. The invented waterproof device has a leakage current less than 10 μA.

In one embodiment, the material capable of generating quantum-tunnelling electrons is selected from the group consisting of an insulator, a semi-conductor, a polymer, a paste, electroconductive particles, an organic material, an inorganic material, a nanomaterial and their combinations thereof.

Preferably, the polymer comprises silicone, epoxy resin or polyurethane.

In one embodiment, the film has a thickness less than 200 nm.

In one embodiment, the waterproof device comprises circuit boards, batteries. chips, electron devices or switches.

In other words, the claimed method comprises the following steps. Touch a conductor to surface of a subject that has a coating film, the subject comprises the invented waterproof devices; apply force to the conductor to deform an area of the coating film to generate quantum-tunnelling effect in a deformed area of the coating film. The quantum tunnelling electrons penetrate through the coating film to the subject; and remove the conductor from the deformed area of the coating film to restore the appearance of the coating film.

Briefly, the method is to apply a conductor to deform the waterproof film and then generate conductance of the non-insulator.

In still another aspect, the present invention provides a second method for making the waterproof device electro-conduction. The method comprises the following steps. Provide a conductor; perform a procedure to have the conductor go through the film of the waterproof device, wherein the film is formed by a recoverable deformation material; make the waterproof device electro-conduction by direct contacting the conductor with the body of the waterproof device; and remove the conductor from the body to allow the film recover to the original shape of the waterproof device. The waterproof device has a leakage current less than 10 μA.

In one embodiment, the recoverable deformation material is selected from the group consisting of a paste, an oil, a ester, a polymer, an organic material, an inorganic material, a nanomaterial and their combinations thereof.

Preferably, the polymer comprises silicone, epoxy resin or polyurethane.

In one embodiment, the film has a thickness more than 30 nm.

In one embodiment, the waterproof device comprises circuit boards, batteries, light-emitting diodes, semi-conductors, panels, connectors, touching panels, keyboards, sensors, chips, electron devices or switches.

Briefly, the second method is to force a conductor to pass through the film and then directly contact with the non-insulator to generate conductance of the non-insulator. Herein, the conductance refers to electrical conductance.

Accordingly, the present invention discloses a waterproof device and its electroconductive methods. In particular, the claimed waterproof device comprises a film and a body. The film is coated on a part or all surface of the body and is formed by one comprises a recoverable deformation material or a material capable of generating quantum-tunnelling electrons. Generally, the film has a thickness more than 30 nm. The electroconductive methods include two different mechanisms, one is to achieve electro-conduction by the quantum-tunnelling electrons transferring and another is to achieve electro-conduction by directly contacting the conductor with the body protected by the film. Both of them are able to reduce leakage current less than 10 μA.

### BRIEF DESCRIPTION OF THE DRAWINGS

FIG. 1 illustrates the steps described in the second embodiment;

FIG. 2 illustrates the steps described in the third embodiment;

FIG. 3 illustrates testing results of a circuit board fabricated according to the present invention;

FIG. 4 illustrates the contact angle of resin and electrode in the circuit board;

FIG. 5 illustrates the leakage current in a printed circuit board (IPC-B-25A) treated by three different methods.

FIG. 6 shows a Bluetooth earphone fabricated according to the present invention;

FIG. 7 shows a drone controller fabricated according to the present invention;

FIG. 8 shows a LED controller fabricated according to the present invention;

FIG. 9 shows a solar panel's connectors and its junction box fabricated according to the present invention;

FIG. 10 shows a battery fabricated according to the present invention and a reference without treating the coating film;

FIG. 11 illustrates the testing result of the battery A fabricated according to the present invention;

FIG. 12 illustrates the testing result of the battery B fabricated according to the present invention; and

FIG. 13 illustrates the total leakage current in a printed circuit board (IPC-B-25A) treated by two different methods.

### BRIEF DESCRIPTION OF THE PREFERRED EMBODIMENTS

In a first embodiment, the present invention discloses a waterproof device. The waterproof device comprises a film and a body, wherein the film is coated on surface of the body to protect the body from moisture, corrosion, oxidation, fouling, and damages from environment. The film is made of one comprises polymers, organic chemicals, inorganic chemicals, nanomaterials, a hybrid of organic and inorganic material, and a hybrid of the above materials and microstructures. In particular, the film is a deformable material and capable of generating quantum tunnelling electrons. Preferable, the film is a self-healing material and capable of recovering deformation.

In one example of the first embodiment, the waterproof device comprises conductors, semiconductors, connectors, electron devices, circuit boards, touch panels, keyboards, sensors and/or batteries.

In a second embodiment, the present invention provides a method for making the claimed waterproof device electro-conduction. The method comprises steps described as following: provide a conductor; perform a procedure to have the conductor contact the film of the claimed waterproof device. The film is formed by a material capable of generating quantum-tunnelling electrons; make the claimed waterproof device electro-conduction by the quantum-tunnelling electrons transferring; and remove the conductor from the film to recover the original shape of the claimed waterproof device. The invented waterproof device has a leakage current less than 10 μA.

In general, a subject is the waterproof device described in the aforementioned. The first method comprises the steps of (1) Touch a conductor to surface of a subject, wherein the surface of the subject has a coating film for protecting the inside body from moisture and oxidation; (2) Apply force to the conductor to deform an area of the coating film, so as to generate quantum-tunnelling effect in a deformed area of the coating film, where the quantum-tunnelling electrons penetrate through the coating film to the inside body; and (3) Remove the conductor from the deformed area of the coating film to restore the appearance of the coating film.

In a preferred example of the second embodiment, a thickness of the coating film is less than 200 nm.

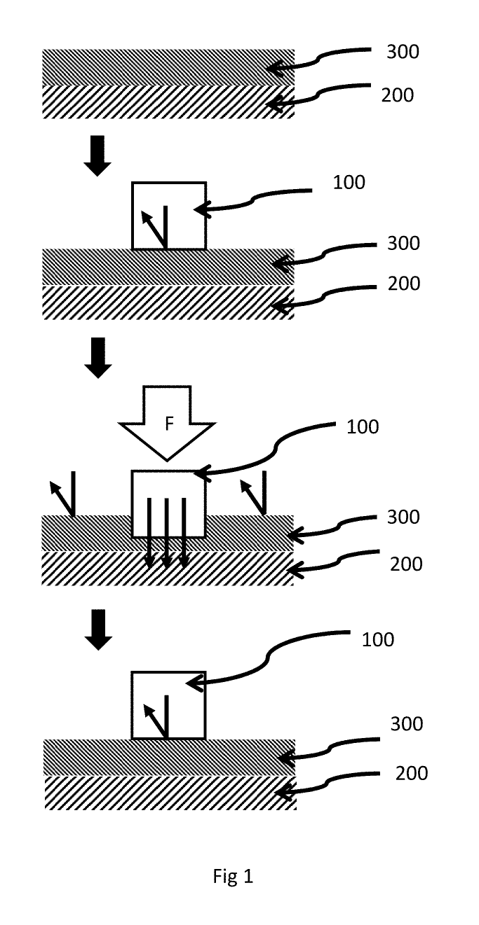

As shown in FIG. 1, a subject comprises the coating film 300 as a protecting layer and a non-insulator 200. Touch the conductor 100 to surface of the subject, and apply external force (F) to the conductor 100 to deform an area of the coating film 300 to generate quantum tunnelling effect in a deformed area of the coating film 300, The quantum-tunnelling electrons penetrate through the coating film 300 to the non-insulator 200 and make the subjects electro-conduction. Finally, remove the conductor 100 from the deformed area of the coating film 300 to restore the appearance of the coating film 300. The subject is then electro-conduction by the quantum-tunnelling electrons.

The advantage of the first method is that only the deformed area of the coating film generates quantum-tunnelling electrons. There is none of electrons in area outside of the deformed area. As a result, the first method is much preferred to apply in waterproof electric device, instrument and equipment.

In a third embodiment, a second method for making the waterproof device electro-conduction comprises the following steps. Provide a conductor; perform a procedure to have the conductor go through the film of the waterproof device, wherein the film is formed by a recoverable deformation material; make the waterproof device electro-conduction by direct contacting the conductor with the body of the waterproof device; and remove the conductor from the body to allow the film recover to the original shape of the waterproof device. The waterproof device has a leakage current less than 10 μA.

Generally, a subject is the waterproof device described in the aforementioned. The second method comprises the following steps. (1) Touch a conductor to surface of a subject, wherein the surface of the subject has a coating film for protecting inside body from moisture and oxidation; (2) Pass the conductor through an area of the coating film to have the conductor directly contact with the inside body; and (3) Remove the conductor from the inside body and then the coating film to restore the appearance of the subject.

In a preferred example of the third embodiment, a thickness of the coating film is more than 30 nm.

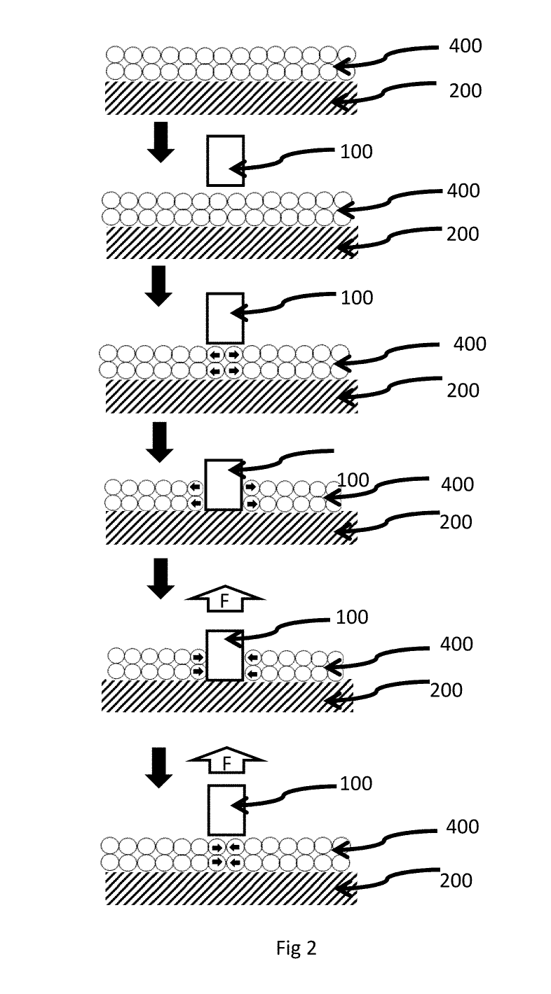

As shown in FIG. 2. A subject comprises a coating film 400 as a protecting layer and a non-insulator 200. The coating film 400 is a self-healing material and capable of recovering deformation. Touch a conductor 100 to surface of the subject. Apply force to have the conductor 100 pass through an area of the coating film 400 and directly contact with the non-insulator 200. Remove the conductor 100 from the non-insulator 200 to restore the appearance or shape of the subject. The subject is then electro-conduction by the conductor.

The advantage of the second method is that the area outside of the passing through area of the coating film still keep insulating. As a result, the method is much preferred to apply in waterproof electric device, instrument and equipment.

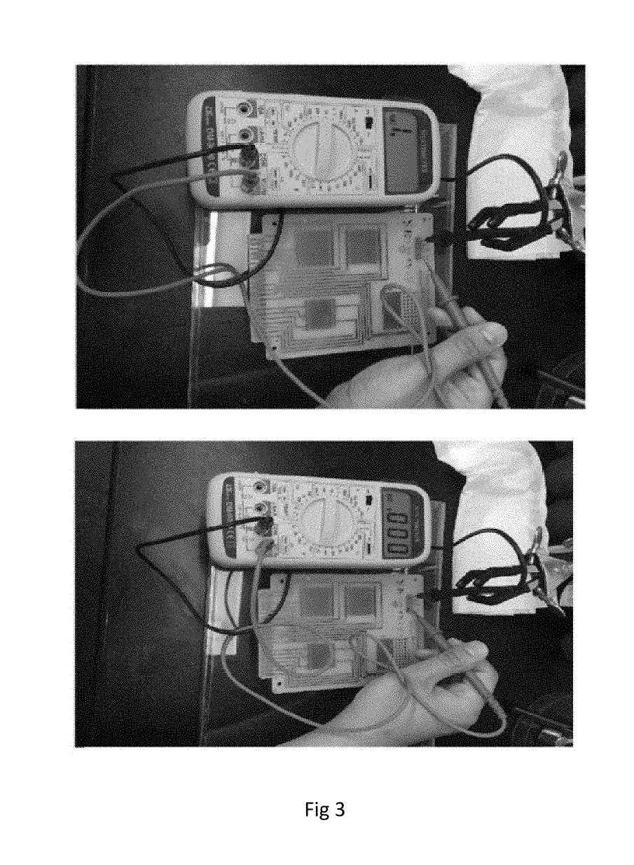

As shown in FIG. 3, the invented circuit board (IPC-B-25A) is protected by a silicone or polysiloxane film, and test results shown in the invented circuit board is electro-conductive and has a measured value of 1 shown in a galvanometer.

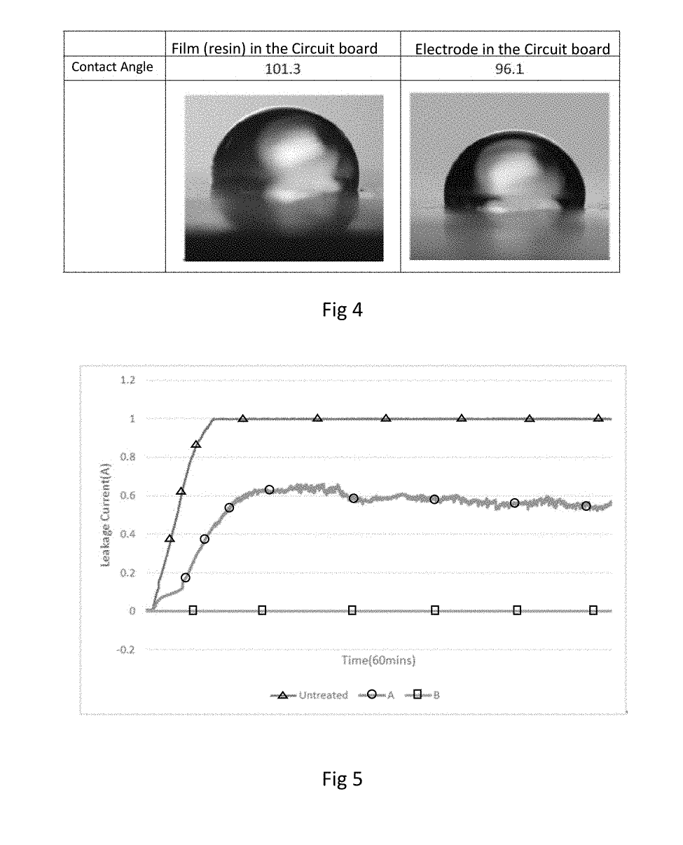

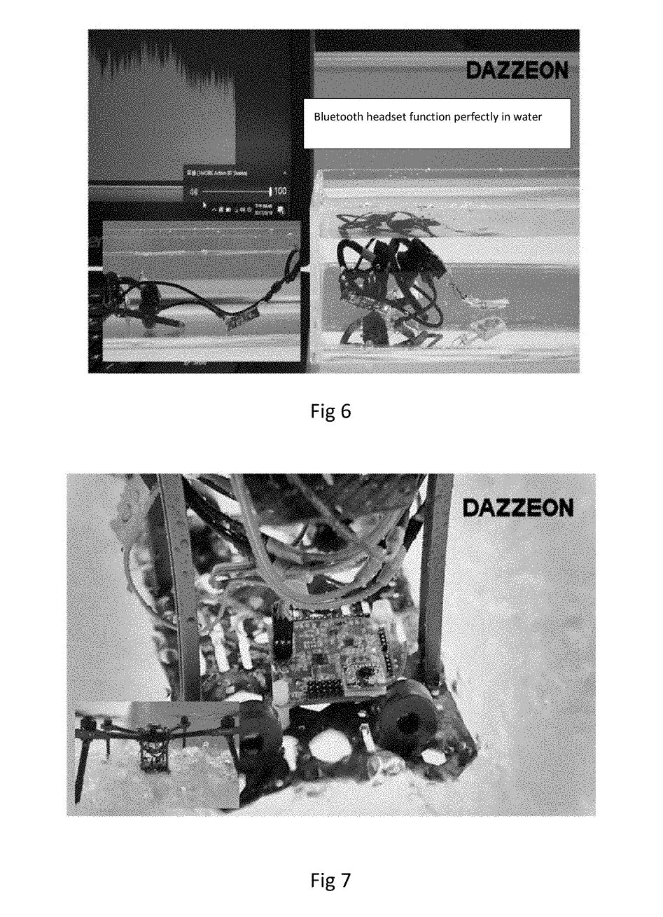

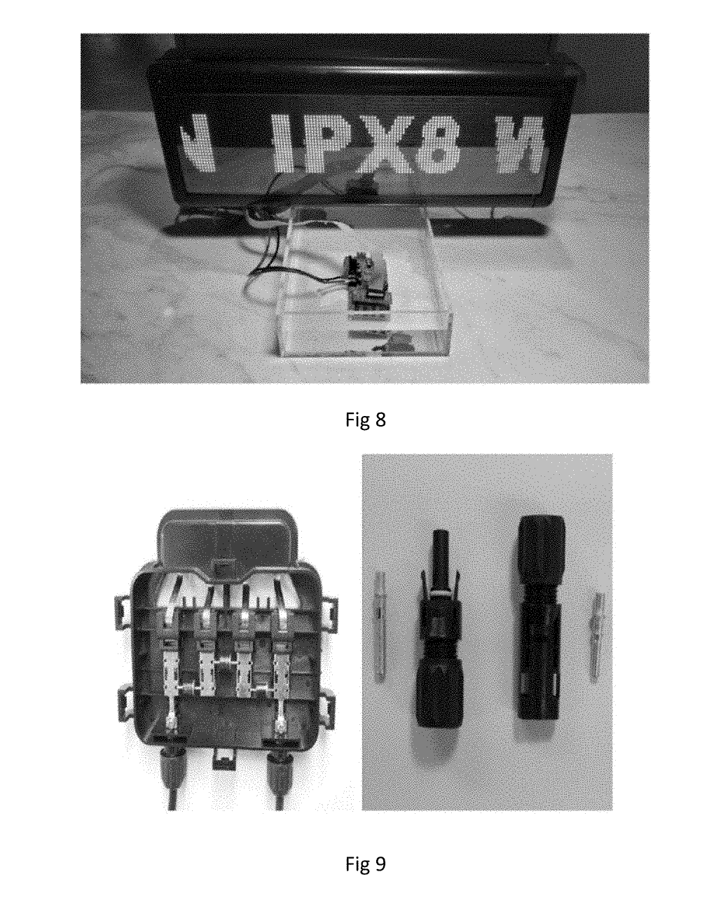

As shown in FIG. 4, the invented circuit board (IPC-B-25A) coated with a silicone or polysiloxane polymer has a contact angle more than 90 degree. This result indicates that the invented circuit board has hydrophobic property and is waterproof. Besides, the part of the polymer has a contact angle of 101.3 degree and the electrode has a contact angle of 96.1 degree in the above circuit board.

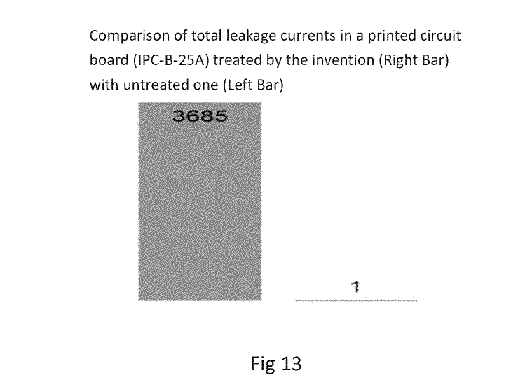

As shown in FIG. 5, the present invention (B) reduces leakage current of the circuit board (IPC-B-25A) less than 1 uA, however, a traditional circuit board (A) has a leakage current about 600 mA. Moreover, an untreated circuit board has a leakage current over 1 A within 10 minutes. As shown in FIG. 13, the invention provides an unexpected result and the waterproof effectiveness of the invented waterproof device is 3685 folds when compare to a circuit board treated by a traditional method. The waterproof performance is calculated on the basis of ratio of total amount of leakage current.

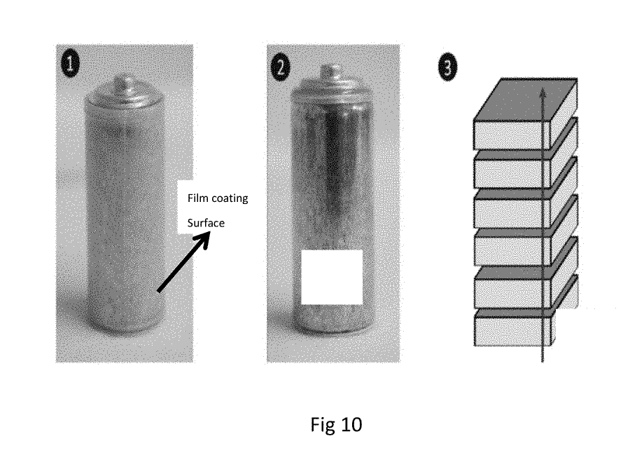

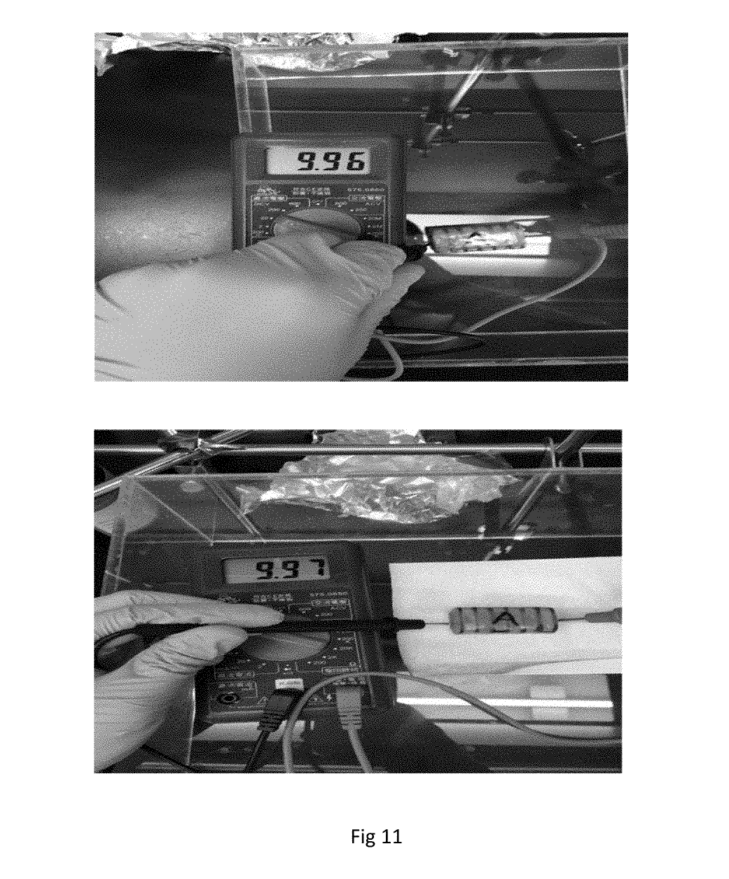

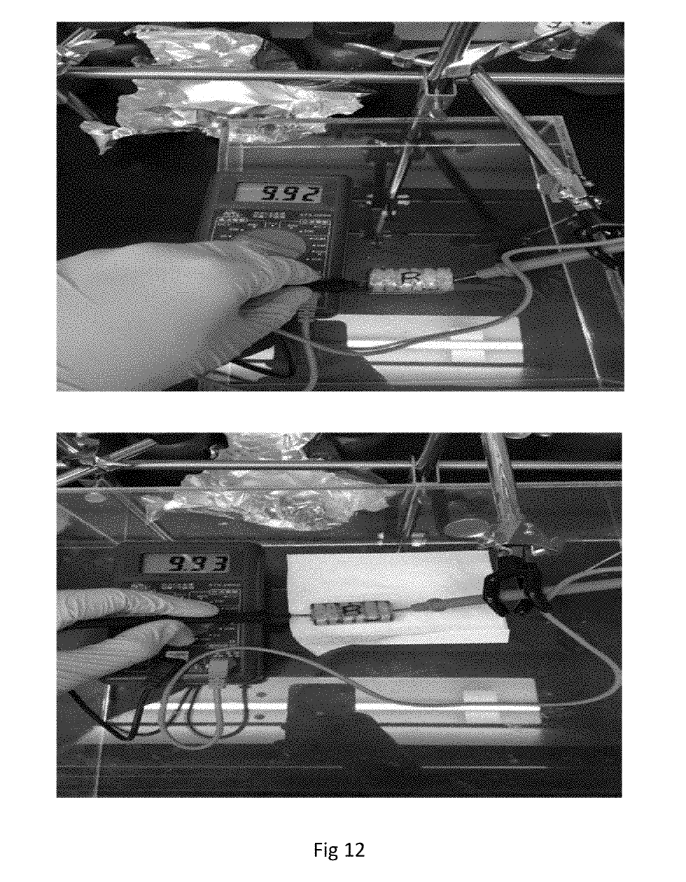

As shown in FIG. 10, FIG. 11 and FIG. 12, the battery fabricated according to the invention shows the working voltage (9.96-9.97 V, 9.93-9.92 V) is unchanged during testing period. Accordingly, the battery module coated with the film is protected from oxidation and capable of being electroconductive between each battery cell inside the battery module.

In conclusion, the present invention discloses a waterproof device and method of application thereof. Typically, the invented waterproof device is an electric device that has the coating film on its part or all of surface. The coating film is a deformable material or a material capable of generating quantum-tunnelling electrons. Most importantly, the coating film is a self-healing material and capable of recovering the deformation. Secondly, the coating film protects the device from moisture, corrosion, oxidation, fouling and damages from environment. Hence, the electric device can operate under water or other liquids

While the invention has explained in relation to its preferred embodiments, it is well understand that various modifications thereof will become apparent to those skilled in the art upon reading the specification. Therefore, the invention disclosed herein intended to cover such modifications as fall within the scope of the appended claims.

What is claimed is:

1. A waterproof device, comprising a body and a film which coats a part or all surface of the body, wherein the film is formed by one comprises a recoverable deformation material or a material capable of generating quantum-tunnelling electrons, and has a thickness more than 30 nm.

2. The waterproof device of claim 1, wherein the recoverable deformation material is selected from the group consisting of a paste, an oil, a ester, a polymer, an organic material, an inorganic material, a nanomaterial and their combinations thereof.

3. The waterproof device of claim 2, wherein the polymer comprises silicone, epoxy resin or polyurethane.

4. The waterproof device of claim 1, wherein the material capable of generating quantum-tunnelling electrons is selected from the group consisting of an insulator, a semi-conductor, a polymer, a paste, electroconductive particles, an organic material, an inorganic material, a nanomaterial and their combinations thereof.

5. The waterproof device of claim 4, wherein the polymer comprises silicone, epoxy resin or polyurethane.

6. The waterproof device of claim 1, comprising circuit boards, batteries, light-emitting diodes, semi-conductors, panels, connectors, touching panels, keyboards, sensors, chips, electron devices or switches.

7. The waterproof device of claim 1, having a leakage current less than 10 μA.

8. A method for making the waterproof device of claim 1 electro-conduction, comprises:
(1) providing a conductor;
(2) performing a procedure to have the conductor contact the film of the waterproof device of claim 1, wherein the film is formed by a material capable of generating quantum-tunnelling electrons;
(3) making the waterproof device of claim 1 electro-conduction by the quantum-tunnelling electrons transferring; and
(4) removing the conductor from the film to recover the original shape of the waterproof device of claim 1, wherein the waterproof device of claim 1 has a leakage current less than 10 μA.

9. The method of claim 8, wherein the material capable of generating quantum-tunnelling electrons is selected from the group consisting of an insulator, a semi-conductor, a polymer, a paste, electroconductive particles, an organic material, an inorganic material, a nanomaterial and their combinations thereof.

10. The method of claim 9, wherein the polymer comprises silicone, epoxy resin or polyurethane.

11. The method of claim 8, wherein the film has a thickness less than 200 nm

12. The method of claim 8, wherein the waterproof device of claim 1 comprises circuit boards, batteries, light-emitting diodes, semi-conductors, panels, connectors, touching panels, keyboards, sensors, chips, electron devices or switches.

13. A method for making the waterproof device of claim 1 electro-conduction, comprises:
(1) providing a conductor;
(2) performing a procedure to have the conductor go through the film of the waterproof device of claim 1, wherein the film is formed by a recoverable deformation material;
(3) making the waterproof device of claim 1 electro-conduction by directly contacting the conductor with the body of the waterproof device of claims 1; and
(4) removing the conductor from the body and then the film to recover the original shape of the waterproof device of claim 1, wherein the waterproof device of claim 1 has a leakage current less than 10 μA.

14. The method of claim 13, wherein the recoverable deformation material is selected from the group consisting of a paste, an oil, a ester, a polymer, an organic material, an inorganic material, a nanomaterial and their combinations thereof.

15. The method of claim 14, wherein the polymer comprises silicone, epoxy resin or polyurethane.

16. The method of claim 13, wherein the film has a thickness more than 30 nm

17. The method of claim 13, wherein the waterproof device of claim 1 comprises circuit boards, batteries, light-emitting diodes, semi-conductors, panels, connectors, touching panels, keyboards, sensors, chips, electron devices or switches.
